(19) United States
(12) Patent Application Publication
(10) Pub. No.: US 2020/0391321 A1
(43) Pub. Date: Dec. 17, 2020

(54) METHOD FOR ASSEMBLING A RING INSIDE A TUBULAR COMPONENT USING MAGNETIC PULSES

(71) Applicant: ADM28 S.ÀR.L, LUXEMBOURG (LU)

(72) Inventor: ERIC MANDEL, SAINT QUENTIN (FR)

(21) Appl. No.: 16/957,024

(22) PCT Filed: Dec. 19, 2018
(86) PCT No.: PCT/EP2018/085859

§ 371 Date: Jun. 22, 2020

(30) Foreign Application Priority Data
Dec. 26, 2017 (FR) 17 63207

(51) Int. Cl. B23K 20/06; B21D 26/14

(52) U.S. Cl. CPC B23K 20/06; B23K 2101/06; B21D 26/14

(57) ABSTRACT

A method for assembling a ring inside a tubular component by magnetic pulse welding. The thickness of the wall of the tubular component is reduced to form a trapezoidal recess on the periphery of a longitudinal portion of the tubular component. A ring is positioned around the tubular component facing the recess. The ring has a shape that compliments that of the recess. The assembly made up of tubular component and ring is positioned in an opening of a coil such that the ring is positioned facing the coil. The assembly is welded using magnetic pulses generated by the coil.

### FIELD OF THE INVENTION

The present invention is in the field of welding, more particularly the field of magnetic pulse welding. The present invention relates to a method for assembling a ring in a tubular component.

### BACKGROUND OF THE INVENTION

In certain industrial fields, for example such as motor vehicle construction, the production of certain particular components requires assembling a ring made of a particular material, for example of copper, in a tubular component that is made of a different material, for example of stainless steel.

The assembly thus obtained therefore has a dual function at the ring.

On the one hand, the ring can have a function of mechanical fuse insofar as the ring made of copper represents a structural weakness of the assembly. The assembly will thus have a tendency to break at the ring in the case of an impact.

On the other hand, the ring made of copper can have a function of electrical contact, for example to control or regulate the flow rate of a fluid passing through the tubular component and carrying a more or less significant electrical current according to the flow rate. Copper is indeed a better conductor of electricity than stainless steel.

It is known to create such an assembly by soldering. FIG. 1 schematically shows how a ring 5 can be assembled in a tubular component 4 by soldering. FIG. 1 is shown according to a cross-sectional view in a longitudinal axis XX′ of the tubular component 4.

The inner diameter d₅₁ of the ring 5 is greater than the inner diameter d₄₁ of the tubular component 4, and it is less than the outer diameter d₄₂ of the tubular component 4. As for the outer diameter d₅₂ of the ring 5, it is greater than the outer diameter d₄₂ of the tubular component 4.

To be able to assemble the ring 5 in the tubular component 4, the following should be successively carried out:
forming, by machining, a recess on a longitudinal portion 43 of the wall 40 of the tubular component 4 on its periphery, the recess being made starting from an outer surface 42 of said wall 40, so that at the recess the outer surface 42 of the wall 40 of the tubular component 4 has a diameter substantially equal to the inner diameter d₅₁ of the ring 5 (it is in this recess that the ring 5 will be housed),
applying in the recess a fine layer of solder 6, for example a layer of silver,
sectioning the tubular component 4 into two parts according to a sectioning plane S orthogonal to the axis XX′ and passing through the middle of the recess,
inserting each of the two sectioned ends of the tubular component 4 into the ring 5,
welding the ring 5 to the tubular component 4 by soldering.

It is then necessary to machine the component obtained by this assembly to eliminate bulges in the solder and to obtain a smooth appearance of the inner and outer surfaces of the wall of the assembly.

The welding by soldering involves bringing the assembly obtained to a high temperature to melt the layer of solder 6 at the copper/stainless steel interface, then carrying out a rapid cooling to bond the two materials to each other.

The welding by soldering has, however, numerous disadvantages. Indeed, it is a method particularly complex to implement. For the soldering to be carried out under good conditions, there should be a particularly clean interface between the ring made of copper and the tubular component made of stainless steel. This is obtained by a complex cleaning method that can cause the appearance of a porosity of the ring made of copper at the soldering surface. It thus becomes difficult to control the conditions of rupture of the mechanical fuse represented by the ring. Moreover, the use of a third material, namely the solder, can hinder the electrical contact at the ring. Also, the alignment of the two pieces of the tubular component is particularly difficult. Moreover, this problem of alignment is also accentuated by the thermal impacts represented by the steps of heating and of cooling of the soldering and which can cause a deformation of the assembly.

### OBJECT AND SUMMARY OF THE INVENTION

The goal of the present invention is to overcome all or a part of the disadvantages of the prior art, in particular those disclosed above.

For this purpose, and according to a first aspect, the present invention proposes a method for assembling a ring in a tubular component. Said tubular component includes a cylindrical wall having an inner surface and an outer surface. The ring and the tubular component are made from metal materials. The method includes the steps of:
reducing, over a longitudinal portion of the tubular component, a thickness of the wall of the tubular component so as to form a trapezoidal recess on the periphery of said longitudinal portion, the reduction in the thickness of the wall of the tubular component being obtained by removal of a layer of material from the outer surface of the wall,
positioning the ring around the longitudinal portion, the ring having, facing the recess, an inner surface having a shape complementary to that of the recess of the tubular component,
positioning the tubular component/ring assembly in an opening of a coil, in such a way that the longitudinal portion is disposed facing said coil,
welding the ring to the tubular component by a magnetic pulse generated by the coil.

The ring is for example made of copper, while the tubular component is made of stainless steel (other choices of material are, however, possible). “Tubular component” means that the component has the shape of a tube, over all or a part of its length, at least at a zone of overlapping between the ring and the recess.

Magnetic pulse welding (MPW), also routinely called “magnetic welding”, uses electromagnetic forces to create a “cold weld” at ambient temperature. This allows to weld two different metal materials to each other without having to use heat or a third bonding material like in the case of solder. An atomically and chemically pure assembly is thus obtained, that is, the assembly has a perfect interface between the ring and the tubular component without a barrier formed by a third polluting material. During the step of magnetic pulse welding, the ring is projected against the tubular component with a force such that the atoms of the two metals share their electrons, thus creating a metal assembly by mixing the two base materials.

In a longitudinal cross-sectional view along an axis of the tubular component, the recess has the shape of a trapezoid. The long base of this trapezoid is located at the outer surface of the wall of the tubular component. The angle formed by said long base and a side of the trapezoid that is not a base has a particular importance in the magnetic welding method. It is indeed via this angle, called “collision angle” or “angle of impact”, that the magnetic pulse welding can take place. The bonding of the ring to the tubular component is indeed carried out mainly at the two non-parallel sides of the trapezoid. During the step of magnetic welding, the air is forced out at a high speed along these inclined sides of the recess and impurities are stripped from the first layers of the material at the interface between the ring and the tubular component, which thus allows a bond at the atomic level.

“Complementary shape” means that the inner surface of the ring that is positioned facing the recess has a similar but inverted shape with respect to the shape of the recess, so that the ring is housed in the recess during the step of magnetic welding.

In specific embodiments, the invention can further include one or more of the following features, taken alone or according to all the technically possible combinations.

In specific embodiments, the assembly method includes, after the step of magnetic pulse welding, a step of machining the ring involving eliminating a layer of material from an outer surface of said ring, in such a way that said outer surface of the ring is flush with the outer surface of the tubular component.

“Flush with” means that the outer surface of the ring is leveled with the outer surface of the tubular component. This machining, carried out after the step of magnetic welding, thus allows to obtain a perfectly smooth outer surface of the product obtained by the assembly of the ring in the tubular component. Besides the esthetically pleasing appearance, this provides an advantage in terms of security since any protruding and potentially cutting part is eliminated at the outer surface of the assembly.

In specific embodiments, the assembly method includes, after the step of magnetic pulse welding, a step of machining the wall of the tubular component involving eliminating a layer of material from the inner surface of the wall of the tubular component, in such a way that the inner surface of the wall is flush with the inner surface of the ring.

This machining, carried out after the step of magnetic welding, allows to ensure the electrical conductivity between the fluid circulating in the tube and the ring. Indeed, the fine layer of stainless steel remaining under the inner wall of the ring is eliminated by this machining. The assembly obtained is thus equivalent to two pieces of tube connected by a ring, and at the ring, the inside of the tube is directly in contact with the inner surface of the ring made of copper. This machining can also allow to optimize the function of mechanical fuse.

In specific embodiments, the steps of machining the outer surface of the ring and the inner surface of the tubular component are carried out simultaneously.

In specific embodiments, the trapezoid corresponding to the shape of the recess according to a longitudinal cross-sectional view in an axis of the tubular component has a long base at the outer surface of the wall of the tubular component, and a short base opposite to said long base, and each angle defined by said long base and a side of the trapezoid is between 8° and 20°.

Such a value of the collision angle indeed allows to obtain optimal conditions for the magnetic pulse welding.

In specific embodiments, the ring is made of copper and the tubular component is made of stainless steel.

### BRIEF DESCRIPTION OF THE DRAWINGS

The invention will be better understood upon reading the following description, given as an example that is in no way limiting, and made in reference to FIGS. 1 to 5 which show:

FIG. 1: diagram of the assembly of a ring in a tubular component by soldering (figure already described in the prior art),

FIG. 2: diagram according to a perspective view of a device for assembly by magnetic welding,

FIG. 3: diagram, according to a view in a longitudinal cross-section, of the positioning of a tubular component and of a ring in the coil of a device for assembly by magnetic welding,

FIG. 4: diagram, according to a view in a longitudinal cross-section, of the assembly obtained by magnetic welding of the ring in the tubular component,

FIG. 5: diagram of another shape of the ring possible for the assembly method according to the invention.

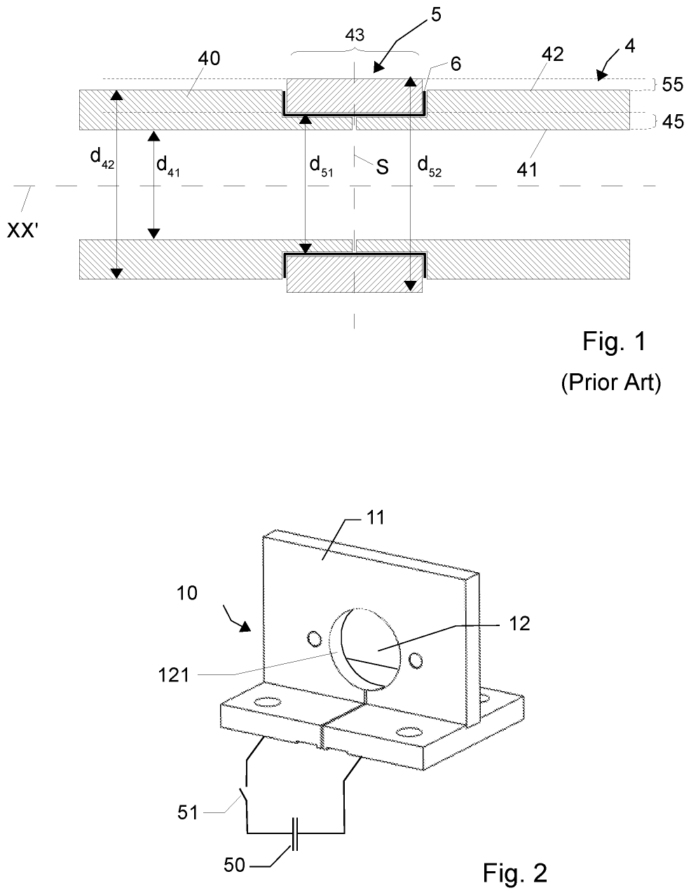

In these drawings, references identical from one drawing to another designate identical or analogous elements. For reasons of clarity, the elements shown are not necessarily to scale, unless otherwise mentioned.

### DETAILED DESCRIPTION OF AN EMBODIMENT OF THE INVENTION

The assembly method according to the invention has the goal of carrying out the assembly of a ring in a tubular component by magnetic welding.

FIG. 2 schematically shows a device adapted to carrying out magnetic pulse welding.

The device includes a coil 10, a storage unit 50 and one or more switches 51, as illustrated in FIG. 2.

The storage unit 50 is connected to the coil 10 and to the switch(es) 51. The storage unit 50 is configured to accumulate a strong energy, for example of approximately several tens of kilojoules (kJ).

In a preferred embodiment, the storage unit 50 is a bank of discharge capacitors.

The coil 10 includes, as illustrated in FIG. 2, a body 11 in which an opening 12 defined by a surface 121 called peripheral is made. Said tubular opening is configured to receive the tubular component and the ring, with a view to their welding. In other words, the opening 12 has for example a circular transverse cross-section, the diameter of which is greater than a maximum transverse cross-section of the ring.

The body 11 is made from a material having specific characteristics in terms, on the one hand, of mechanical resistance to plastic deformation to circulate a very high intensity current, of approximately several hundred thousand amperes, therein, and on the other hand of resistance to high temperatures (that is to say a high melting temperature) to not melt during the welding method.

In one embodiment, the body 11 is made of steel.

The coil 10 is configured for a high-intensity current to be able to circulate therein and produce a magnetic field.

The coil 10 is also configured for the density of the current in a zone of the coil to be sufficient to satisfy the welding conditions. This zone is called active part.

In the case of a coil 10 as described in this embodiment, the current is concentrated, in the active part, on a layer defined by the peripheral surface 121 having a thickness corresponding to a skin thickness. The current thus generates, in the opening 12, a concentrated magnetic field. In the non-limiting example of a coil 10 made of steel, the skin thickness is approximately several millimeters for a frequency of several tens of kHz.

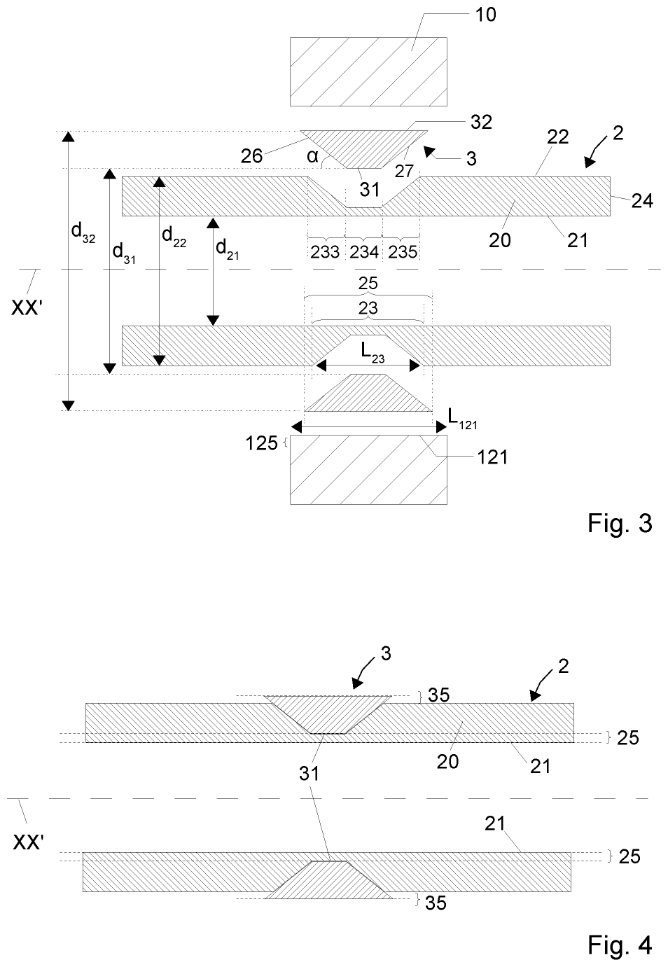

FIG. 3 schematically shows, according to a view in a longitudinal cross-section along an axis XX′, the positioning of a tubular component 2 and of a ring 3 in the coil 10 of a device for assembly by magnetic welding as described in reference to FIG. 2.

“Tubular component” means that the tubular component 2 has the shape of a tube, over all or a part of its length, and at least at a longitudinal portion 23 against which the ring 3 will be pressed during the assembly. The tubular component 2 preferably has a circular transverse cross-section. In other words, the tubular component 2 preferably has a wall 20 that has the shape of a right circular cylinder (that is, a cylinder of revolution) at least over said longitudinal portion 23.

Although said tubular component 2 is described, and illustrated, in a detailed manner in the case of a circular transverse cross-section, other shapes of transverse cross-sections, such as oval, rectangular, or triangular, can apply.

As illustrated in FIG. 3, the cylindrical wall 20 of the tubular component 2 extends along the axis XX′ and has an inner surface 21 and an outer surface 22. The tubular component 2 has an inner diameter d₂₁ and an outer diameter d₂₂. The difference between the outer diameter d₂₂ and inner diameter d₂₁ thus corresponds to twice the thickness of the wall 20 of the tubular component 2.

In the example in question, and given in a manner that is not at all limiting, the wall 20 of the tubular component 2 is made of stainless steel and has a thickness of 1.75 mm. The outer diameter d₂₂ of the tubular component 2 is 13.5 mm.

The assembly method according to the invention will now be described.

In a first step, the thickness of the wall 20 of the tubular component 2 is reduced over the longitudinal portion 23, having a length L₂₃.

Preferably, the longitudinal portion 23 does not start at an end 24 of the tubular component 2.

The thickness of the wall 20 of the tubular component 2 is reduced to form a trapezoidal recess on the periphery of the longitudinal portion 23. In other words, the thickness of the wall 20 of the tubular component 2, over the length of the longitudinal portion 23, is reduced in such a way that:
over a first part 233 of the longitudinal portion 23, the thickness of said wall 20 is monotone decreasing,
over a second part 234 of the longitudinal portion 23, in the continuity of the first part, the thickness of said wall 20 of the tubular component 2 is constant,
over a third part 235 of the longitudinal portion 23, in the continuity of the second part, the thickness of said wall 20 of the tubular component 2 is monotone increasing.

The thickness of the wall 20 of the tubular component 2 is advantageously reduced starting from the outer surface 22 of the wall 20.

The reduction in the thickness of the wall 20 is obtained by removal of a layer of material from the outer surface 22 of the wall 20 of the tubular component 2.

A means for implementing this first step involves, for example, reducing the thickness of the wall 20 of the tubular component 2 by machining.

The trapezoid corresponding to the shape of the recess according to a longitudinal cross-sectional view in the axis XX′ thus has a long base having a length L₂₃ at the outer surface 22 of the wall 20 of the tubular component 2. It has a short base having a length shorter than L₂₃ parallel to the long base. In the example in question and illustrated in FIG. 3, the trapezoid is isosceles and has an angle α defined by said long base and one of the non-parallel sides of the trapezoid.

As illustrated in FIG. 3, the trapezoidal recess is made in such a way that the height of said trapezoid (that is to say the distance between its long base and its short base) is less than the thickness of the wall 20 of the tubular component 2. Also, the thickness of the ring 3 is at least equal to the height of said trapezoid.

The length L₂₃ of the longitudinal portion 23 is at most equal to an axial length L₁₂₁ of the peripheral surface 121 of the coil 10.

In a second step, the ring 3 is positioned around the tubular component 2.

The ring 3 has a minimum transverse cross-section greater than the outer diameter d₂₂ of the tubular component 2. Preferably, the transverse cross-section of the ring 3 has a shape similar to that of the transverse cross-section of the tubular component 2. In the example described and illustrated, the ring 3 has a circular transverse cross-section. The ring 3 thus has an inner diameter d₃₁ greater than the outer diameter d₂₂ of the tubular component 2, and an outer diameter d₃₂. The difference between the outer diameter d₃₂ and the inner diameter d₃₁ of the ring 3 thus corresponds to twice the maximum thickness of the ring 3.

In the example in question and presently described in a non-limiting way, the ring 3 has a thickness of 2 mm.

The ring is preferably made from a metal material. Advantageously, the material of the ring is different than that of the tubular component. In the example presently described, the material of the ring 3 is copper.

The ring 3 is positioned around the tubular component 2, coaxially, while forming, at their superposition, an overlapping zone 25.

The tubular component 2 is inserted into the ring 3 so that the overlapping zone 25 covers at least the longitudinal portion 23 of the tubular component 2.

As illustrated in FIG. 3, the ring 3 has an outer surface 32 and an inner surface 31. The inner surface 31 of the ring 3 is intended to be positioned facing the longitudinal portion 23 of the wall 20 of the tubular component 2, and it has a shape complementary to that of the recess that has been made in the wall 20 of the tubular component 2. In other words, the inner surface 31 of the ring 3 that is positioned facing the recess has a similar but inverted shape with respect to the shape of the recess, so that the ring 3 is housed in the recess during the later step of magnetic welding.

The ring 3 thus also has a trapezoidal shape. The short base of said trapezoid has the same length as the short base of the trapezoid of the shape of the recess. The height of the trapezoid formed by a longitudinal cross-section of the ring 3 along the axis XX′ can nevertheless have a greater height than the height of the trapezoid of the shape of the recess. In the example in question, said trapezoid is isosceles and the angle formed by the long base of the trapezoid and each side of the trapezoid is equal to the angle α previously defined.

The ring 3 is positioned, at the overlapping zone 25, so that the shape complementary to the recess of its inner surface 31 is placed facing the recess. During the step of magnetic welding, the ring 3 will be housed in the recess of the wall 20 of the tubular component 2.

In a third step, the tubular component 2/ring 3 assembly is positioned in the circular opening 12 of the coil 10 of the device for assembly by magnetic welding, in such a way that all or a part of the overlapping zone 25 is facing the peripheral surface 121 of the coil 10.

More particularly, the tubular component 2 and the ring 3 are disposed in the opening 12 of the coil 10 so that the overlapping zone 25 is placed facing the active part 125 of the coil 10.

The fastening means allowing to maintain the tubular component 2 and the ring 3 in the opening 12 of the coil 10 are not shown in FIG. 3.

The tubular component 2 and the ring 3 are maintained in the opening 12 of the coil 10 coaxially to each other and to the opening 12 according to the axis XX′.

The tubular component 2 is for example maintained in place by fastening means exterior to the coil. The ring 3 is for example maintained in place by wedging in a ring made of insulating material, for example a ring made of plastic approximately 1 mm thick, positioned between the peripheral surface 121 of the coil 10 and the ring 3. The outer diameter of this ring made of plastic corresponds to the diameter of the opening 12 of the coil 10. The inner diameter of this ring made of plastic corresponds to the outer diameter d₃₂ of the ring 3.

The order of implementation of the second and third steps is not imposed and, according to embodiments of the method, can be carried out in the reverse order of the order described, or carried out simultaneously without modifying the result of said steps.

After these steps, the tubular component 2 and the ring 3 are positioned with respect to each other and in the coil 10.

The assembly method according to the invention then includes a step of magnetic pulse welding of the tubular component 2/ring 3 assembly.

The storage unit 50 accumulates a strong energy. During the closing of the switch(es) 51, the coil 10 is connected to the storage unit. The energy is thus discharged very rapidly, in approximately several microseconds, onto the coil 10 and a high-intensity current circulates in the active part 125 of the coil 10.

The current generates a variable magnetic field between the coil 10 and the ring 3 and induces eddy currents in the ring 3.

The current induced in the ring 3 associated with the surrounding magnetic field develop significant volumetric forces called Lorentz forces in the ring. These Lorentz forces exert a magnetic pressure on the ring 3 radially in all points of said ring 3, thus accelerating it in the direction of the tubular component 2.

Under the action of these centripetal forces, the ring 3 is thus projected at a very high speed against the tubular component 2. The impact of the ring 3 against the tubular component 2 causes the immediate welding of the ring 3 to the tubular component 2.

For the magnetic pulse welding of the ring 3 to the tubular component 2 to be effective, the impact between the copper of the ring 3 and the stainless steel of the tubular component 2 must occur in specific conditions in which the two surfaces can exchange their atoms. For this purpose, the two surfaces must be atomically and chemically pure. For this, the two surface are cleaned by the action of the impact of the copper on the stainless steel by forcing out the air which is heated, gathers speed (the speed can reach 700 m/s), sweeps the two surfaces, and eliminates all the pollution (dust, impurities in the first layers of the material, etc.). The creation of this micrometric “jet” of solid material stripped from the surfaces to be assembled occurs at the beginning of the contact between the two components and propagates at a very high speed along the entire length of the assembly lines corresponding to the non-parallel sides 26, 27 of the trapezoid. The contact surfaces are thereby exposed, thus allowing a bond on the atomic level, but without melting.

The speed of ejection of the air is dependent on the dimension of the collision angle α. It has been observed that for the materials and the dimensions in question in the example described, optimal welding conditions occur when the angle α is between 8° and 20°. In the example in question, the angle α preferably takes the value of 10°. It should be noted that, for reasons of clarity of the drawing, the angle α shown in FIG. 3 is greater than the aforementioned range. In reality, the trapezoid has a markedly “flatter” shape.

Upon the very high speed impact of the ring 3 made of copper against the tubular component 2 made of stainless steel, the two materials pass, at their interface, from a solid state into a viscoplastic state for a very short period of time (several tens of μs), thus causing their atomic bonding.

After this step of magnetic pulse welding, the ring 3 and the tubular component 2 are mainly welded at the surfaces formed on the periphery of the tubular component 2 by the non-parallel sides 26, 27 of the trapezoidal recess that was made in the wall 20 of the tubular component 2.

During the step of magnetic welding, the ring 3 is deformed. More particularly, its diameter is reduced under the action of the electromagnetic forces engendered by the coil 10 when it is pressed into the recess around the tubular component 2 over the longitudinal portion 23.

FIG. 4 schematically shows, according to a view in a longitudinal cross-section, the assembly obtained by magnetic welding of the ring 3 in the tubular component 2.

As illustrated in FIG. 4, there remains a layer 25 of material in the wall 20 of the tubular component 2 under the ring 3. In the example in question, this layer 25 has a thickness of 0.5 mm.

It can be advantageous to eliminate this layer 25 of material by an additional step of machining starting from the inner surface 21 of the wall 20 of the tubular component 2, in such a way that said inner surface 21 is flush with the inner surface 31 of the ring 3. “Flush with” means that the inner surface 21 of the wall 20 of the tubular component 2 is at the same level as the inner surface 31 of the ring 3.

This means that after this step of machining, the inner surface of the ring 3/tubular component 2 assembly is mainly made of stainless steel except at the ring 3 where it is made of copper. This advantageously allows to ensure good electrical conductivity between a fluid passing inside the tubular component 2 and the ring 3. Moreover, the function of mechanical fuse carried out by the ring 3 is also optimized.

Nevertheless, this machining step remains optional if the function of mechanical fuse is the main interest, and if the structural weakness provided by the assembly consisting of the ring 3 made of copper and of the fine layer 25 of stainless steel is suitable for the desired use.

As illustrated in FIG. 4, there also generally remains, after the step of magnetic welding, a layer 35 of material of the ring 3 protruding from the outer surface 22 of the wall 20 of the tubular component 2.

It can be advantageous to eliminate this layer 35 of material by an additional step of machining starting from the outer surface 32 of the ring 3, in such a way that the outer surface 32 of the ring 3 is flush with the outer surface 22 of the wall 20 of the tubular component 2.

This means that after this machining step, the outer surface of the ring 3/tubular component 2 assembly is entirely smooth. Besides the esthetically pleasing appearance, this provides an advantage in terms of security since any protruding and potentially cutting part is eliminated at said outer surface of the assembly.

It should be noted that these two optional machining steps carried out after the step of magnetic welding can be carried out simultaneously.

It is in particular possible to avoid the step of machining the outer surface 32 of the ring 3 by determining the appropriate thickness of the ring 3 so that after the step of magnetic pulse welding, the outer surface 32 of the ring 3 is directly flush with the outer surface 22 of the wall 20 of the tubular component 2.

These machining steps carried out after the assembly by magnetic welding are particularly costly and it is therefore advantageous to avoid them to reduce the cost of production of the components made by the assembly method according to the invention.

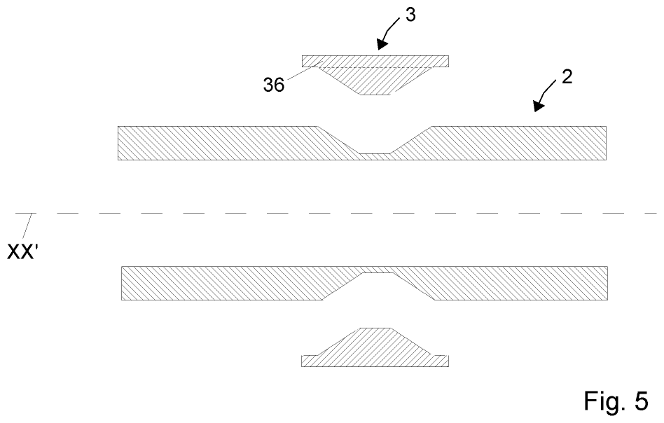

It should be noted that the ring 3 does not necessarily have a trapezoidal shape as illustrated in FIG. 3 or 4. The ring 3 can indeed have various shapes in which only a part corresponds to the trapezoidal shape complementary to the shape of the recess made in the wall 20 of the tubular component 2. For example, FIG. 5 schematically shows a ring 3, the particular shape of which has a rectangular base 36 to which a trapezoidal shape complementary to the shape of the recess is added.

The above description clearly illustrates that by its various features and their advantages, the present invention achieves the goals that it set.

In particular, the method for magnetic pulse welding is extremely fast (a pulse typically lasts between 10 and 100 μs and the only constraints of total cycle time are due to the positioning of the components in the assembly device).

It is a reliable method, well adapted to mass production, that offers numerous possibilities for welding between materials having different melting points.

Since this is cold welding, there is no undesirable deformation of the assembled components.

There is no need for complex cleaning of the bonding surfaces, like in the case of soldering for example.

An advantage of the method for magnetic pulse welding lies in the fact that the assembly of the two components is carried out in the solid state, which allows to eliminate the known problems of conventional welding involving the melting of the materials.

The invention has been described as an example that is in no way limiting for a tubular component 2 made of stainless steel and a ring 3 made of copper having very specific dimensions. It should be noted, however, that other materials and other dimensions can be chosen for the ring 3 and the tubular component 2. The shape of the recess and more particularly the collision angle α are thus adequately determined, in a known manner for a specialist in magnetic pulse welding.

The choice of the materials, of the shapes and/or of the dimensions of the ring 3 and of the tubular component 2 are merely alternatives of the present invention. The ring 3 and the tubular component 2 are preferably made of different materials in such a way that they have different mechanical and/or electrical properties.

1-6. (canceled)

7. A method for assembling a ring in a tubular component, the tubular component comprising a cylindrical wall having an inner surface and an outer surface, the ring and the tubular component being made from metal materials, the method comprising:
reducing, over a longitudinal portion of the tubular component, a thickness of the cylindrical wall of the tubular component so as to form a trapezoidal recess on a periphery of said longitudinal portion, the reduction in the thickness of the cylindrical wall of the tubular component being obtained by removing a layer of material from the outer surface of the cylindrical wall;
positioning the ring around the longitudinal portion facing the trapezoidal recess, the ring comprising an inner surface having a shape complementary to that of the trapezoidal recess of the tubular component;
positioning a tubular component and ring assembly in an opening of a coil, such that the ring is disposed facing said coil; and
welding the ring to the tubular component by a magnetic pulse generated by the coil.

8. The assembly method of claim 7, further comprising, after welding the ring, machining the ring by eliminating a layer of material from an outer surface of the ring, such that the outer surface of the ring is flush with the outer surface of the cylindrical wall of the tubular component.

9. The assembly method of claim 7, further comprising, after welding the ring, machining the cylindrical wall of the tubular component by eliminating a layer of material from the inner surface of the cylindrical wall of the tubular component, such that the inner surface of the cylindrical wall is flush with an inner surface of the ring.

10. The assembly method of claim 8, further comprising, after welding the ring, machining the cylindrical wall of the tubular component by eliminating a layer of material from the inner surface of the cylindrical wall of the tubular component, such that the inner surface of the cylindrical wall is flush with an inner surface of the ring; and wherein the machining the outer surface of the ring and the machining the inner surface of the cylindrical wall of the tubular component are carried out simultaneously.

11. The assembly method of claim 7, wherein a trapezoid corresponding to a shape of the trapezoidal recess according to a longitudinal cross-sectional view in an axis of the tubular component has a long base at the outer surface of the cylindrical wall of the tubular component and a short base opposite to the long base, and each angle defined by the long base and a side of the trapezoid is between 8° and 20°.

12. The assembly method of claim 7, wherein the ring is made of copper and the tubular component is made of stainless steel.

13. The assembly method of claim 11, wherein the ring is made of copper and the tubular component is made of stainless steel.
